(19) United States
(12) Patent Application Publication
(10) Pub. No.: US 2023/0014479 A1
(43) Pub. Date: Jan. 19, 2023

(54) COMPOSITIONS FOR THE REMEDIATION OF PER- AND POLY-FLUOROALKYL SUBSTANCES IN WASTEWATER

(71) Applicant: Bio-Chem, Incorporated, Cleveland, TN (US)

(72) Inventors: Kenneth Brummett, Cleveland, TN (US); Jonathan Brummett, Cleveland, TN (US)

(73) Assignee: Bio-Chem, Incorporated, Cleveland, TN (US)

(21) Appl. No.: 17/950,168

(22) Filed: Sep. 22, 2022

Related U.S. Application Data
(63) Continuation-in-part of application No. 17/836,375, filed on Jun. 9, 2022.
(60) Provisional application No. 63/247,886, filed on Sep. 24, 2021.
(60) Provisional application No. 63/201,179, filed on Apr. 16, 2021.

(51) Int. Cl. C02F 1/52

(52) U.S. Cl. CPC C02F 1/5245; C02F 1/5263; C02F 2101/36

(57) ABSTRACT

Methods and compositions for remediating wastewater formed by water and contaminants, which may include per- and poly-flouroalkyl substances (PFAS), using a wastewater treatment system including a collecting unit, a dewatering unit, a drying unit, and a baking unit. Wastewater provided to the collecting unit is dosed by adding a compound to the wastewater in an amount that is sufficient to cause the contaminants to separate from the water and to form a sludge. The compound can include combinations of salts, glacial acetic acid, chitosan, and water. The sludge is dewatered with the dewatering from a first dryness level a second dryness level. The dewatered sludge is then dried in the drying unit from the first dryness level to a third dryness level. The dried sludge is then baked at a sufficiently high enough temperature that chemical bonds of at least a portion of the contaminants are destroyed.

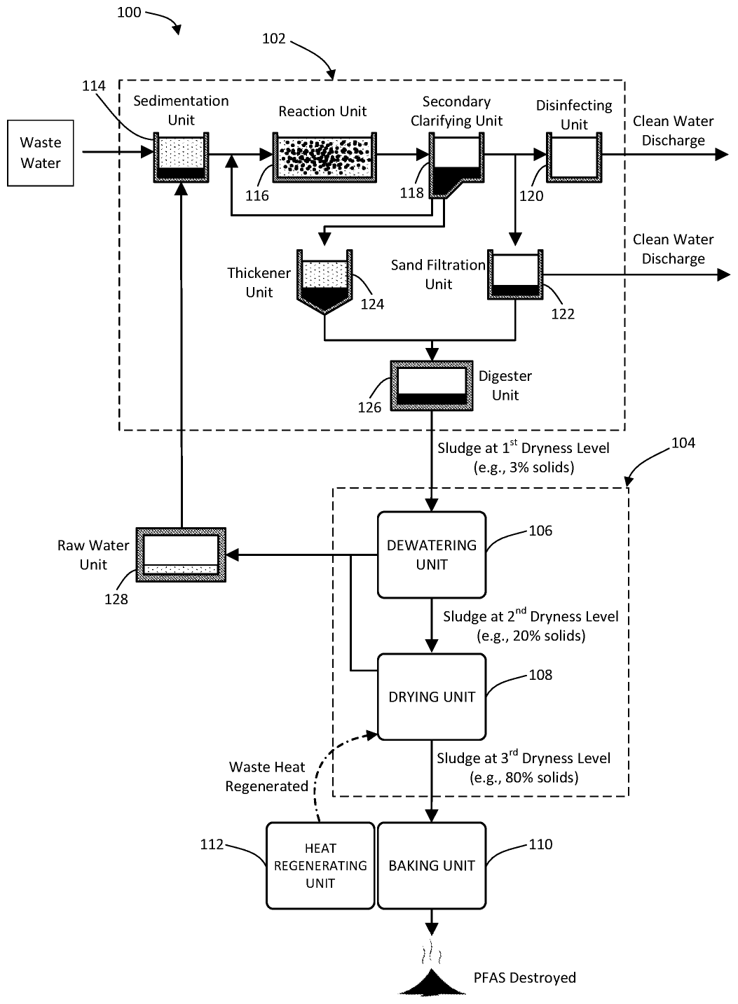

### CROSS-REFERENCE TO RELATED APPLICATIONS

This application is a continuation in part application to U.S. patent application Ser. No. 17/836,375, entitled REMEDIATION OF PER- AND POLY-FLUOROALKYL SUBSTANCES IN WASTEWATER, and filed Jun. 9, 2022, which claims the benefit of U.S. Provisional Application No. 63/201,179, filed Apr. 16, 2021 and entitled PFAS IN SITU REMEDIATION IN WATER. This application also claims the benefit of U.S. Provisional Application No. 63/247,886, filed Sep. 24, 2021, and entitled COMPOSITIONS AND METHODS FOR THE REMOVAL OF PFAS AND OTHER CONTAMINANTS IN WATER. Each of the foregoing applications is incorporated herein by reference in its entirety.

### FIELD

The present invention relates to wastewater treatment. More particularly, the present invention relates to compositions and methods for treating wastewater having biological and chemical pollutants in water, such as phosphor salts, nitrogen, pathogens, viruses, heavy metals, dyes, per- and poly-fluoroalkyl substances (PFAS), etc., and wherein the pollutants are captured and removed for subsequent destruction and remediation.

### BACKGROUND

Wastewater treatment entails removing and treating many different types of pollutants or contaminants found in wastewater. Various processes are known and available in the art, but the basic approaches generally utilize biological and/or chemical treatment processes. Often, in a primary treatment step, solid components in the wastewater are removed via mechanical separation, for instance with the aid of screens and grit chambers and by allowing the solid impurities to settle in a preliminary settling device. Over the years, this primary treatment has been unable to meet the increasing demands for water quality. As a result, primary treatment is now commonly followed by a second treatment step, where the wastewater is further treated with a chemical treatment process and/or a biological treatment process. However, the second treatment step is also insufficient for meeting water quality demands becoming more stringent and for removing certain pollutants dangerous to humans.

Chemical treatment generally involves the use of precipitation chemicals such as polymers, iron salts, or aluminum salts. These precipitation chemicals react or bond with, flocculate, and/or coagulate impurities in the water like phosphates or heavy metals. As a result, these impurities precipitate out of solubility into particles referred to as a “floc.” Flocculation, or coagulation, plays a central role in this process, where dissolved and colloid impurities are destabilized and large floc aggregate are formed. The aggregate can then be removed from the water in subsequent clarification or filtration processes. The speed of flocculation and the quality of the floc aggregates formed is central to the effectiveness of the treatment process. Not only does it affect the removal of the soluble or colloid impurities from the water, it also affects the characteristics (e.g. sludge quantity, volume, compactness and water content) of the sludge formed and that must also be treated.

Traditional chemical flocculation agents used for wastewater treatment include alum, lime, and a range of synthetic polymers. Adding the minimum amount of chemicals required for effective treatment of the wastewater is of utmost importance. Excess treatment chemicals lead to inefficient and overly expensive treatment. Additionally, certain polymer-, ferric-, or aluminum-based chemicals used to facilitate flocculation or coagulation create risks of toxicity, treatment system corrosion, or chemical dependency of the system.

Removal of contaminants from water is essential in any water treatment process as the health of the environment, human populations, and animal populations depends on it. For example, excessive amounts of nutrients lead to eutrophication in water, suffocating fish and other aquatic creatures, reducing their populations. Heavy metals can also be carcinogenic to humans as well as wildlife. Although certain traditional chemical treatment and filtration processes can remove contaminants from water, these processes can be expensive and their corrosive and pollutive qualities degrade the infrastructures where they are applied. Additionally, traditional methods of contaminant removal have proven ineffective for certain contaminants, such as PFAS. Removal of PFAS compounds from water is of utmost importance.

Per- and polyfluoroalkyl substances (PFAS) are a group of over 5,000 human-made chemicals manufactured for their oil and water-resistant properties. PFAS compounds are commonly called “forever chemicals” because their removal from wastewater and subsequent destruction has proven incredibly difficult. The most common PFAS are perfluorooctanoic acid (PFOA) and perfluorooctanesulfonic acid (PFOS). These chemicals are commonly found in a range of consumer products, industrial processes, etc. For example, PFAS are often found in fabrics and materials with non-stick and fire-resistant properties such as carpets and food packaging, non-stick coatings such a TEFLON® brand non-stick coatings, and fire-fighting foam.

Due to their prevalence, government agencies, particularly the Environmental Protection Agency (EPA), are currently seeking better understanding of PFAS and the risks they pose to the public. The EPA's review also includes a consideration of end-of-life disposal approaches for PFAS, including the use of landfills, incinerators, and recycling, and how those approaches would impact the environment.

It is believed that continued exposure to PFAS above specific levels can lead to adverse health effects in humans including cancer, liver damage, and immune system disorders. For example, it is believed that PFAS are toxic in the parts per trillion (ppt) range. Among other things, PFAS are believed to cause kidney and testicular cancer, to increase cholesterol levels, and to cause detrimental developmental effects to the immune and thyroid system and fetuses during pregnancy. In order to provide a margin of protection against the potentially harmful effects of a lifetime of exposure to PFOA and PFOS present in drinking water, the EPA has established health advisory levels at 70 parts per trillion (ppt). In other words, these health advisories state the combined concentration of PFOA and PFOS in drinking water should be below 70 ppt to protect against these harmful effects. In order for PFAS-contaminated water to comply with the EPA's recommendation, the concentration of PFAS must be reduced for potable water. On the other hand, no EPA regulations or recommendations currently exist for managing PFAS in biosolids. Yet, when PFAS-containing products are produced and disposed of (e.g., land-applied biosolids), PFAS compounds can leach into soils, groundwater, and surface water, where they accumulate and persist as non-biodegradable, toxic compounds. They have also been shown to bio-accumulate or to build up in the blood and organs over time. Therefore, in waste materials (e.g., biosolids and sewage sludge/effluents), PFAS compounds should be destroyed before the waste can be safely disposed of.

With respect to end-of-life disposal, conventional wastewater treatment processes are not designed to remove and destroy PFAS. Instead, secondary filtering processes, such as granular activated carbon (GAC), reverse osmosis (RO), or ion exchange filters are commonly used to remove PFAS from water supplies. However, simply removing PFAS from water supplies does not destroy the molecules. Even after removal, they remain toxic. Additionally, removal of PFAS by conventional filtration methods creates a new set of issues. For example, currently available technology has limited effectiveness in removing PFAS. PFAS particles also quickly foul filtration media and the media cannot be cleaned for reuse, like it can be with other chemicals. Further, the filter media cannot be taken to a landfill because the PFAS will leach out into the landfill and eventually reach groundwater, further perpetuating the PFAS/filtration cycle.

Destroying PFAS is difficult and is often thought to be impossible. PFAS molecules are structured as chains of carbon (C) and fluorine (F) atoms with attached functional groups of oxygen (O), hydrogen (H), nitrogen (N), sulfur (S), and phosphorus (P). The carbon-fluorine bond is one of the shortest and strongest bonds in nature and does not easily break down under natural conditions, leading to the nickname “Forever Chemicals.”

Therefore, what is needed is improved methods and compounds for removing and then destroying PFAS compounds in the wastewater remediation process.

### NOTES ON CONSTRUCTION

The use of the terms “a”, “an”, “the” and similar terms in the context of describing embodiments of the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships, unless otherwise specified herein or clearly indicated as having a different relationship by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY

The above and other problems are addressed by methods and compositions for remediating wastewater formed by water, contaminants, and per- and poly-fluoroalkyl substances (PFAS). In preferred embodiments, the method includes the step of providing a wastewater treatment system having a collecting unit, a dewatering unit, a drying unit, and a baking unit. Wastewater is provided to the collecting unit from a wastewater source. The wastewater is dosed in the collecting unit by adding a compound to the wastewater in an amount that is sufficient to cause the contaminants, including PFAS, to separate from the water and to form a sludge. The sludge is then provided to the dewatering unit at a first dryness level having a first percent solids and is then dewatered. The dewatered sludge is then provided to the drying unit at a second dryness level having a second percent solids that is higher than the first percent solids and is then dried. Lastly, the dried sludge is provided to the baking unit at a third dryness level having a third percent solids that is higher than the second percent solids and is baked. More particularly, the sludge is baked at a sufficiently high enough temperature that chemical bonds of at least a portion of the PFAS is destroyed.

In certain embodiments the dosing compound is a mixture of about 50-90% by weight Calcium Carbonate (CaCO₃), and about 10-50 % by weight Borax, and Carbon (C) in amounts effective for achieving flocculation and removal of contaminants in wastewater during treatment. In certain other embodiments, the dosing compound may be Calcium Carbonate without Borax or Carbon in an amount effective for achieving flocculation and removal of contaminants in wastewater. Preferably, the composition is a mixture formed of fine powders of powders of Calcium Carbonate, Borax, and Carbon.

In certain embodiments, the compound is a mixture of 36-60% by weight of a first salt, about 2-24% by weight of a second salt, and water (H₂O). Preferably, the first salt is Lanthanum Chloride (LaCl₃) or Cerium Chloride (CeCl₃) and the second salt is Calcium Chloride (CaCl₂), Sodium Chloride (NaCl), or Borax. In certain preferred embodiments, the composition compromises about 36-60 parts per weight of the first salt, about 2-24 parts per weight of the second salt, and about 100 parts per weight of water.

In certain embodiments, the compound is a mixture of about 1-2 parts by weight Chitosan, about 1-2 parts by weight glacial acetic acid (CH₃COOH), and about 1-2 parts by weight of a salt. In certain embodiments, the salt is Calcium Chloride, Sodium Chloride, Lanthanum Chloride, or Cerium Chloride. In certain embodiments, the composition further includes about 100-200 parts by weight of water. In certain other embodiments, the composition is prepared by dissolving 1-2 parts by weight of chitosan in 100 parts by weight of water, adding 1-2 parts by weight of glacial acetic acid, 1-2 parts by weight of the salt and about 100 parts by weight of water.

### BRIEF DESCRIPTION OF THE DRAWINGS

Further advantages of the invention are apparent by reference to the detailed description when considered in conjunction with the figures, which are not to scale so as to more clearly show the details, wherein like reference numerals represent like elements throughout the several views, and wherein:

The FIGURE is a diagram illustrating a wastewater treatment system that may be used for remediating wastewater formed by water, contaminants, and per- and poly-fluoroalkyl substances (PFAS) according to an embodiment of the present invention.

### DETAILED DESCRIPTION

Referring now to the drawings in which like reference characters designate like or corresponding characters throughout the several views, there is shown in the FIGURE a diagrammatic view of a wastewater treatment system 100 that may be used in remediating wastewater formed by water, contaminants and per- and poly-fluoroalkyl substances (PFAS), according to a preferred method of the present invention.

A first step in a preferred method is to provide wastewater treatment system 100. In preferred embodiments, the system 100 includes an open-air aeration basin, an enclosed mixing chamber, or other similar clarifying devices (referred to generally as collecting unit 102), a drying unit 104 that preferably includes a dehumidification or dewatering unit 106 and a dryer unit 108, and then a baking unit 110. Certain preferred embodiments of the wastewater treatment system 100 further include heat regenerating unit 112. Each of these components and their function in the presently disclosed methods is described in further detail below.

In the illustrated embodiment, the collecting unit 102 is formed by several components. The overall purpose of the collecting unit 102 is to collect contaminated wastewater, to form a sludge of the contaminants, to begin separating the sludge from the water, and to begin drying the sludge. Initially, wastewater is provided to the collecting unit 102 from a wastewater source. In preferred embodiments, wastewater is provided to a sedimentation unit or primary clarifying unit 114, where the largest and heaviest particles settle out of the wastewater. From there, the wastewater preferably flows over a weir (not shown) of the primary clarifying unit 114 and is sent to a reaction unit 116, such as an open-air aeration basin or an enclosed mixing chamber.

Within the reaction unit 116, the wastewater is dosed with a compound, such as a mineral compound, in an amount that causes the PFAS and other contaminants to coagulate, precipitate, to flocculate, or otherwise separate from the water to form a sludge. In certain embodiments, two or more different compounds are added to the wastewater in order to promote separation of PFAS and other contaminants from water. In other embodiments, the compound is added in multiple components/steps within the collecting unit 102, including the sedimentation unit 114, the reaction unit, 116, and the secondary clarifying unit 118. Multiple compositions can be applied together at the same step in the reaction unit, or at unique times/steps in the treatment process.

In certain embodiments of a treatment method, the wastewater undergoes a treatment process consisting of a preliminary treatment, aeration, initial settling, secondary settling, and dewatering. The compound can be added at any stage in the treatment, either once during the treatment process or multiple times. Additionally, multiple compounds can be added during any stage in the treatment process. Finally, the multiple compounds can be added together or separately at one or multiple steps in the treatment process.

Suitable compounds for dosing the water can include a composition of about 50-90% by weight Calcium Carbonate, about 10-50% by weight Borax, and Carbon in amounts effective for achieving flocculation and removal of contaminants during treatment of the wastewater. This composition is preferably a mixture of fine powders of Calcium Carbonate, Borax, and Carbon. In the alternative, a similar compound can include Calcium Carbonate in an amount effective for achieving flocculation and removal of contaminants in wastewater without the use of Borax or Carbon. An alternative compound includes a composition of about 36-60% by weight of a first salt, about 2-24% by weight of a second salt, and water. Exemplary first salts include Lanthanum Chloride and Cerium Chloride. Exemplary second salts include Calcium Chloride, Sodium Chloride, and Borax. Alternatively, the compound can comprise about 36-60 parts per weight of the first salt, about 2-24 parts per weight of the second salt, and about 100 parts per weight of water. Yet another suitable composition for removal of PFAS substances from wastewater is a mixture of about 1-2 parts per weight Chitosan, about 1-2 parts per weight Glacial Acetic Acid, and 1-2 parts per weight of a salt. Effective salts include Calcium Chloride, Sodium Chloride, Lanthanum Chloride, and Cerium Chloride. The composition may also include 100-200 parts per weight of water (H₂O). The composition can be produced by dissolving 1-2 parts per weight Chitosan in 100 parts per weight of water, adding 1-2 parts per weight of glacial acetic acid, 1-2 parts per weight of the salt and about 100 additional parts per weight of water.

The compounds listed above, when applied to contaminated wastewater bond with the contaminants, including PFAS compounds. In certain embodiments, about 2-30 ppm (parts per million of water to be treated) of a composition are applied to achieve acceptable treatment results. However, in other cases, different or other preferred ratios may be determined via bench testing. Differing levels of contaminants may require amounts of the compounds outside of the typical range. In some cases, with a specific gravity of around 2.7 to around 2.9, the compounds, after bonding with contaminants, settle to the bottom of a treatment vessel. The settled sludge is then appropriately treated, as described below. The water becomes clean as the solid material settles to the bottom or is filtered out of the water, and the contaminants are locked into the sludge. In certain cases, analyses following the above treatment steps have shown a reduction of all contaminants, where as little as 9 parts per trillion contaminants in the water remained.

Suitable compounds are also described in U.S. Pat. No. 7,384,573, entitled “Compositions for Wastewater Treatment,” which is hereby incorporated by reference in its entirety. As described in the '573 patent, in certain embodiments, a suitable compound for dosing the wastewater might include at least one of calcium carbonate, magnesium carbonate, lanthanum chloride, or chitosan. In certain embodiments, the compound added to wastewater is a precipitating mineral compound that results in precipitation of PFAS and other contaminants.

In prior water treatment operations, chemicals such as ferric chemicals or aluminum chemicals have been utilized to facilitate flocculation or coagulation. However, these operations create risks such as toxicity, corrosion and “chemical dependency.” For example, historically, the addition of alum has been necessary for flocculation in potable water operations. When used in wastewater treatment plants, it has been difficult to stop using it later on without the treatment operation suffering from shock due to chemical dependency. By using the compositions described above, the use of these toxic and corrosive chemicals may be eliminated or at least reduced significantly. Additionally, the compositions of the present invention are not associated with a chemical dependency because water treatment facilities can stop using these compositions without any adverse effects on the biological populations. Testing has shown that when the compositions of the present invention are used, either alone or in any combination, water treatment operations do not suffer shock when introduced or if removed from the treatment regimen. There have been no indications of harm or chemical dependency to the biological populations. Additionally, they are as effective in half the volume as alum to achieve equivalent results.

The dosing step allows the water and sludge to be separated from one another in a subsequent clarification or filtration process. The speed of separation and the quality of the aggregates forming the sludge are central to the effectiveness of the treatment process, not only because they impact the removal of the impurities from the water, but also because they impact the characteristics (e.g. quantity, volume, compactness and water content) of the sludge formed and its subsequent treatment. In dosing the wastewater, it is important to add the minimum amount of chemicals possible and to obtain good contact with all of the wastewater in order to reduce costs, to maximize efficiency of the treatment process, and to minimize the amount of sludge. In certain embodiments, a biological treatment process, such as an activated sludge process or a trickling filter process, is used to assist in purifying the sludge using microorganisms to digest organic matter in the wastewater and to reduce the overall amount of sludge that must be treated.

Next, the sludge may be further purified in a settling tank or secondary clarifying unit 118. Preferably, at this point in the process, the contaminants have been substantially removed from a large portion of the water. That portion of the water that is free of contaminants may then be passed for further treatment, such as in a disinfecting unit 120, prior to being discharged from the system 100. However, if needed, the water may be recycled back through a portion of the system 100, such through the reaction unit 116, or through a different portion of the system, such as a sand filtration unit 122, for further treatment in order to further remove contaminants from the water. Again, if the water from the sand filtration unit 122 is sufficiently pure and free of contaminants, including PFAS, it may be discharged from the system 100. At the same time, sludge collected in the secondary clarifying unit 118 is optionally, though preferably, transferred to a settling tank or thickener unit 124, where it is further separated from water.

Another optional step is that sludge from the sand filtration unit 122 and thickener unit 124 may then be sent to a digester unit 126 for anaerobic digestion. The presently-disclosed methods may be used with digested or undigested sludge. When a digestion step is employed, digester gas is produced and that digester gas is likely to be contaminated with PFAS or other contaminants. It is believed that this contaminated digester gas could cause the same type of health issues mentioned above, if left untreated. As discussed further below, one such treatment method is to expose the gas to sufficiently high enough temperatures (e.g., incineration) that the chemical bonds forming the contaminants are destroyed such that the contaminants are rendered safe. In preferred embodiments, the digester gas is captured and treated prior to release. As discussed above, during digestion, microorganisms digest organic matter in the sludge. This digestion step helps to provide increased stability of biosolids for later use in land application. Another benefit of the digestion process is that it reduces the overall volume of sludge that must be treated. In preferred embodiments, gases produced by the digestion of the organic matter in digester unit 126 are sent to the baking unit 110 and are burned in order to destroy contaminants that might be found in those gases.

The sludge is then sent or pumped (pump not shown) to the drying unit 104 for further drying and water removal. The drying unit 104 is shown as including both the dewatering unit 106 and the drying unit 108. In some embodiments, the drying unit 104 is formed as a single machine that provides both operations. In other embodiments, separate machines carry out the dewatering and drying processes.

The sludge is first provided to the dewatering unit 106. It is noted here that sludge may bypass the digester unit 126 discussed above and may be, instead, sent directly to the drying unit 104/dewatering unit 106 from the reaction unit 116 or secondary clarifying unit 118 if sufficiently dry. There are a number of dewatering methods and apparatuses that are known in the art that would be well suited for further drying the sludge. For example, dewatering unit 106 could include a centrifuge, belt press, spiral filter press, and the like. In preferred embodiments, the sludge is provided to the dewatering unit 106 at a first dryness level having a first percent solids of between approximately 1% solids and approximately 5% solids. In the illustrated embodiment, sludge having a first dryness level of approximately 3% solids is provided to the dewatering unit 106. Using the dewatering unit 106, the sludge is further dried. Filtrate water from the dewatering process is pumped to the headworks (i.e., the initial stages) of the wastewater treatment system 100. In certain embodiments, this filtrate water may first be pumped to and temporarily held in a raw water unit 128 prior to being sent to the headworks.

Once the sludge is sufficiently dewatered by the dewatering unit 106, it may then be sent to the drying unit 108 for yet additional drying and removal of water. In preferred embodiments, up until this point in the remediation process, water has been removed from the sludge using mechanical means and did not heat the sludge to evaporate water. At this point, the dewatered sludge, which is more of a semi-solid “cake” at this point in the process, can be transported without concern of contaminants escaping into the environment. However, it is believed that, if the sludge is heated and the remaining water is evaporated in an open system, the water vapor could carry contaminants into the environment. This should be avoided in order to limit the negative health consequences discussed above. If the cake is not heated to a temperature to release the remaining moisture from the cell structure, the cake can be stored in a silo (not shown) prior to further drying.

The next step in the remediation process is to dry the cake through the application of heat. For the reasons discussed above, this drying process is preferably carried out in a closed system such that the water vapor released during the drying process is trapped and contaminants carried by the water vapor are not allowed to contaminate the environment. Thus, the drying process is preferably carried out in a drying unit 108 that includes a closed cabinet or other similar closed environment. In preferred embodiments, the sludge is provided to the drying unit 108 at a second dryness level that is higher than the first dryness level. For example, sludge is preferably provided to the drying unit 108 with a second dryness level having a second percent solids between approximately 15% solids and approximately 25% solids. For example, in the illustrated embodiment, sludge is provided from the dewatering unit 106 to the drying unit 108 at a second dryness level of 20% solids.

Using the drying unit 108, the sludge is further dried. In certain embodiments, the sludge is dried to approximately 500° C. to 600° C. Heat for the drying process can be provided by a variety of sources, including any type of fuel or energy type or source (e.g., renewable or non-renewable), waste heat from the remediation process (as described further below), etc. However, in preferred embodiments, the entire remediation process is carried out without the use of petroleum or fuel oils or other petroleum products. As mentioned above, the water vapor produced during the baking process should be captured and filtered for contaminats. For example, the water vapor might be pumped to the headworks of the wastewater treatment system 100 or to a raw water unit 128 and then to the headworks. The filtered, clean water from the drying process may then be discharged from the system 100.

Lastly, the dewatered and dried cake or sludge is provided to the baking unit 110, where it is burned. Preferably, the dried cake is provided to the baking unit 110 at a third dryness level having a third percent solids of approximately 80% solids to approximately 90% solids. In certain preferred embodiments, a gasification process or a pyrolysis process using plasma is utilized to burn the dried cake. Additionally, in certain embodiments, the burning process is controlled using a plasma magnetic field. The temperatures achieved during the burning process should be sufficiently high to destroy at least a portion of the chemical bonds of the various contaminants, specifically PFAS. In preferred embodiments, the PFAS is broken down by the burning process and rendered inert. The precise temperature will vary, depending on the nature of the contaminants in the wastewater. For example, in various embodiments, the dried cake may require baking to approximately 200° C. to 1000° C., to approximately 1200° C., or even to approximately 1600° C. In a preferred embodiment, the cake is baked to 1010° C. (1850° F.) to destroy the contaminants, specifically PFAS.

The system 100, including each of its various major components, are preferably configured to operate in batch or continuous (e.g., 24-hour) modes of operation. Additionally, as noted above, the entire remediation process is preferably carried out without the use of petroleum or fuel oils or other petroleum products. In certain embodiments, the remediation process is carbon neutral, which means that any CO₂ released into the atmosphere during the remediation process is balanced by an equivalent amount of CO₂ being removed from the environment. In preferred embodiments, the remediation process is carbon negative, which means that more CO₂ is removed from the environment during the process than is released to the atmosphere during the process.

In certain preferred embodiments, the drying unit 108, the baking unit 110, and the heat regenerating unit 112 form a closed loop that is configured to prevent gas from escaping the closed loop. To improve the energy efficiency of the remediation process, waste heat from the baking process is preferably recycled through the closed loop or to another area of the remediation process (e.g., digester unit, 126, drying unit 108, etc.) or to generate electricity. In addition to improved efficiency, another advantage of this closed loop system is that there are no odor issues when using a closed loop system.

Thus, advantageously, the present disclosure provides various methods for remediating contaminanted wastewater and for rending certain harmful compounds, specifically PFAS, inert. The table below provides experimental data where these methods were used to remove PFAS compounds. The numbers provided are parts per trillion. As can be seen, in each case, these methods result in a significant percentage of the PFAS compounds being removed (e.g., between 58% and 100% removal).

| | PRE-TREATMENT | POST-TREATMENT | |
|---|---|---|---|
| PFAS | CONCENTRATION | CONCENTRATION | % |
| COMPOUND | (PPt) | (PPt) | REMOVED |
| PFPeA | 126.7 | 53.8 | 58% |
| PFHxA | 2568.06 | 60.6 | 98% |
| PFHpA | 793.95 | 16.6 | 98% |
| PFOA | 2478.9 | 49.8 | 98% |
| PFNA | 142.08 | 1.5 | 99% |
| PFDA | 107.37 | 2.06 | 98% |
| PFBS | 4016.62 | 42.3 | 99% |
| PFPeS | 122.93 | 1.72 | 99% |
| PFHxS | 264.96 | 12.4 | 95% |
| PFOS | 240.79 | 14.7 | 94% |
| 4:2 FTS | 125.54 | 1.11 | 99% |
| 8:2 FTS | 28.11 | Non-detectable (ND) | 100% |
| PFOSA | 104.05 | ND | 100% |
| N-MeFOSAA | 109.93 | 6.78 | 58% |
| N-EtFosaa | 123.68 | 3.49 | 58% |

Other experimental tests were performed in wastewater treatment plants, which tests have shown that increased solids removal can be achieved using 40% less of the presently-disclosed compositions than alum while still achieving comparable results. In a first example, leachate from Republic Services, Inc. was received and treated using the presently-described compositions and method. The leachate had the following pre-treatment and post-treatment characteristics:

| | PRE-TREATMENT | POST-TREATMENT |
|---|---|---|
| | CONCENTRATION | CONCENTRATION |
| COMPOUND | (mg/L) | (mg/L) |
| Chemical oxygen | 50,000 | Non-detectable (ND) |
| demand (COD) | | |
| Lead | 0.931 | ND |
| Zinc | 0.911 | ND |
| Nickel | 0.940 | ND |
| Copper | 0.988 | ND |
| Chromium | 0.955 | ND |
| Cadmium | 0.922 | ND |

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A composition for removal of contaminants in wastewater, the composition comprising a mixture of about 50-90% by weight Calcium Carbonate, and about 10-50% by weight Borax, and Carbon in amounts effective for achieving flocculation and removal of contaminants in water treatment.

2. The composition according to claim 1, wherein the composition is formed by a mixture of Calcium Carbonate, Borax, and Carbon in powder form.

3. A composition for removal of contaminants in wastewater, the composition comprising a mixture of about 36-60% by weight of a first salt, about 2-24% by weight of a second salt, and water.

4. The composition of claim 3 wherein the first salt comprises Lanthanum Chloride or Cerium Chloride.

5. The composition of claim 4 wherein the second salt comprises Calcium Chloride, Sodium Chloride, or Borax.

6. The composition of claim 3 comprising about 36-60 parts per weight of the first salt, about 2-24 parts per weight of the second salt, and about 100 parts per weight of water.

7. The composition of claim 6 wherein the first salt comprises Lanthanum Chloride or Cerium Chloride.

8. The composition of claim 7 wherein the second salt comprises Calcium Chloride, Sodium Chloride, or Borax.

9. A composition for removal of contaminants in wastewater, the composition comprising a mixture of about 1-2 parts by weight Chitosan, about 1-2 parts by weight glacial acetic acid, and about 1-2 parts by weight of a salt.

10. The composition of claim 9 wherein the salt comprises Calcium Chloride, Sodium Chloride, Lanthanum Chloride, or Cerium Chloride.

11. The composition of claim 9 further comprising about 100-200 parts by weight of water.

12. The composition according to claim 11, which is comprised of about 1-2 parts by weight of chitosan in 100 parts by weight of water, about 1-2 parts by weight of glacial acetic acid, about 1-2 parts by weight of the salt, and about 100 parts by weight of water.

13. The composition of claim 12 wherein the salt comprises Calcium Chloride, Sodium Chloride, Lanthanum Chloride, or Cerium Chloride.
